(19) United States
(12) Patent Application Publication
(10) Pub. No.: US 2015/0210897 A1
(43) Pub. Date: Jul. 30, 2015

(54) Adhesive stick and method for its production

(71) Applicant: Kores CE GmbH, Wein (AT)

(72) Inventor: Klaus Münster, Vosendorf (AT)

(73) Assignee: Kores CE GmbH, Wein (AT)

(21) Appl. No.: 14/417,234

(22) PCT Filed: Jul. 16, 2013
(86) PCT No.: PCT/AT2013/000118

§ 371 Date: Jan. 26, 2015

(30) Foreign Application Priority Data
Jul. 31, 2012 (AT) A 849/2012

(51) Int. Cl. C09J 9/00; C09J 133/08

(52) U.S. Cl. CPC C09J 9/005; C09J 133/08

(57) ABSTRACT

In a glue stick made from an aqueous preparation of an acrylic acid ester copolymer as the adhesive component and a detergent gel as the structure-forming substance, wherein sodium salts of C₁₂ to C₂₂ fatty acids, particularly C₁₄ to C₁₈ fatty acids, are contained as the gel structure-forming detergent, the acrylic acid ester has an acrylic acid content of 10-25%, preferably 10-20%, preferably 15-20%.

The invention relates to a glue stick made from an aqueous preparation of an acrylic acid ester copolymer as the adhesive component and a detergent gel as the structure-forming substance, wherein sodium salts of C₁₂ to C₂₂ fatty acids, particularly C₁₄ to C₁₈ fatty acids, are contained as the gel structure-forming detergent.

The invention further relates to a method for producing a glue stick of this kind.

A glue stick and a method for the production thereof are disclosed in DE 10148077 A1 and DE 102009012667 A1.

As can be seen from these documents, glue sticks of the kind mentioned above are rod-shaped adhesives, which are moveably mounted in a closable casing and leave behind an adhesive film when rubbed onto a substrate surface. They contain water-soluble or water-dispersible synthetic polymers with an adhesive character, for example, particularly acrylic acid ester copolymers dissolved in an aqueous-organic liquid phase, such as for example a polyacrylate dispersion, along with a shaping structure substance. Fatty acids in the range C₁₂ to C₂₂ are particularly used as the structure substance. If the intrinsically highly adhesive aqueous preparations of the polymer substances with an adhesive character are heated along with small quantities of the structure substance based on fatty acid detergents to relatively high temperatures, particularly over 50° C., and this solution is allowed to cool off in the resting position, the substance mixture solidifies into a more or less stiff detergent gel, in which the shaping and comparatively rigid micelle structure of such detergent gels mainly becomes evident for the first time. This makes the known formation and handling of such masses in stick form in closable casings possible. The micelle structure is destroyed during rubbing and the rigid mass is thereby converted into a pasty state, in which the adhesive nature of the substance mixture is then highlighted.

The application properties, particularly the sliding properties and abrasion during application, the adhesive properties and the long-term stability are decisive in relation to the quality of such glue sticks. As a general rule, the harder the glue stick, the poorer the adhesive properties. Conversely, a stick which is too soft impairs application. At the same time, during production of the glue stick, the viscosity of the substance mixture containing the aqueous preparation of an acrylic acid ester copolymer and the C₁₂ to C₂₂ fatty acids as the structure-forming components must be kept within the desired limits, so that workability is guaranteed.

The problem addressed by the invention is therefore that of designing a glue stick, such that the criteria mentioned above are optimally taken into account.

To solve this problem, the invention envisages with a glue stick of the kind mentioned above that the acrylic acid ester has an acrylic acid content of 10-25%, preferably 10-20%, preferably 15-20%. The invention is based on the knowledge that the acrylic acid content is responsible for the thickening properties, wherein it has been found that a minimum content of 10% is required in order to reach a compromise between good application properties and sufficient adhesive force. An excessively high acrylic acid content would in turn cause a deterioration in workability during the production process.

It is particularly advantageous for the aqueous preparation of an acrylic acid ester copolymer to have free acid groups, particularly carboxyl groups. The thickening of the substance mixture containing the aqueous preparation of an acrylic acid ester copolymer and the C₁₂ to C₂₂ fatty acids as the structure-forming components starts with the addition of the sodium hydroxide and the neutralisation of the fatty acids and possibly the free acid groups resulting from this.

It has further been found that the choice of fatty acids has positive effects on the hardness of the glue stick that can be achieved. In particular, it has been found that an excessively high proportion of pure stearic acid results in glue sticks which are too soft and do not therefore exhibit optimum application properties. The glue stick according to the invention is therefore preferably developed such that the C₁₂ to C₂₂ fatty acids, particularly C₁₄ to C₁₈ fatty acids, contain up to 30-50 wt %, particularly up to 40-50 wt %, stearic acid, wherein the remainder is preferably formed for the most part from palmitic acid and small quantities of myristic acid. In practice, this is therefore impure stearic acid, for example, which also contains other fatty acids, particularly palmitic and myristic acid, in addition to the aforementioned proportion of pure stearic acid.

In relation to the absolute quantity of fatty acids, a preferred development of the invention envisages that the sodium salts of C₁₂ to C₂₂ fatty acids, particularly C₁₄ to C₁₈ fatty acids, are contained in quantities of 3-8 wt %, particularly 5-8 wt %, relative to the total mass of the stick.

In order to achieve good adhesive properties, it is preferably provided that the aqueous preparation of an acrylic acid ester copolymer, particularly a polyacrylate dispersion, is contained in a quantity of 45-60 wt %, particularly 50-60 wt %, relative to the total mass of the stick.

In addition to the main components of the glue stick according to the invention mentioned hitherto, further components may advantageously be present, particularly in smaller quantities. The formation in relation to this is preferably such that the aqueous preparation of an acrylic acid ester copolymer contains sucrose. The proportion of sucrose is between 5 and 30 wt % relative to the total mass of the stick.

Furthermore, the aqueous preparation of an acrylic acid ester copolymer may also contain polyurethane dispersions. The proportion of the polyurethane dispersions may be between 5 and 30 wt % relative to the total mass of the stick.

Moreover, the aqueous preparation of an acrylic acid ester copolymer may contain starch ether. The proportion of starch ether may be between 5 and 40 wt % relative to the total mass of the stick. The proportion of the starch ether may depend particularly on the viscosity of the substance mixture, wherein a smaller proportion of starch ether is required as the viscosity rises.

Furthermore, customary adjuncts such as softeners, dyes, pigments, fragrances, preservatives and/or moisture-regulating substances may be contained. Monopropylene glycol may preferably be a possibility for use as a softener and/or moisture-regulating substance.

The method according to the invention for producing a glue stick is characterized in that C₁₂ to C₂₂ fatty acids, particularly C₁₄ to C₁₈ fatty acids, as structure-forming parts are blended with an aqueous preparation of an acrylic acid ester copolymer with any acrylic acid content of 10-25%, preferably 10-20%, preferably 15-20%, and adjuncts if necessary and heated to temperatures of at least 50° C., preferably to up to 80° C., until a clear, uniform mixture is created, that a quantity of sodium hydroxide required to neutralize the fatty acids and the free acid groups if necessary is subsequently added and that it is then homogenized, after which the mixture is cast in moulds and cooled without any mechanical influence to form a gel. Preferred developments of the method result from the features and components listed above in connection with the glue stick according to the invention.

The invention is explained below using the following exemplary embodiments, wherein different acrylic acid proportions and different stearic acid proportions are compared.

Glue sticks with the compositions indicated in Table 1 were formulated.

TABLE 1

| | Acrylic acid proportion 10% | | | Acrylic acid proportion 15% | | | Acrylic acid proportion 18% | | |
|---|---|---|---|---|---|---|---|---|---|
| | Glue stick 1 | Glue stick 2 | Glue stick 3 | Glue stick 4 | Glue stick 5 | Glue stick 6 | Glue stick 7 | Glue stick 8 | Glue stick 9 |
| Polyacrylate | 56 | 60 | 52 | 50 | 52 | 49 | 48 | 45 | 47 |
| dispersion | | | | | | | | | |
| Additive | 0.4 | 0.4 | 0.4 | 0.4 | 0.4 | 0.4 | 0.4 | 0.4 | 0.4 |
| Stearic acid 40% | 8 | | | 6 | | | 5 | | |
| Stearic acid 50% | | 6.5 | | | 5 | | | 4 | |
| Stearic acid 98% | | | 4.1 | | | 3.1 | | | 3 |
| Monopropylene | 2 | 2 | 2 | 2 | 2 | 2 | 2 | 2 | 2 |
| glycol | | | | | | | | | |
| NaOH 15% | 28.5 | 21 | 15.4 | 30 | 26 | 21 | 33 | 28 | 24 |
| Residual quantity | | | | | | | | | |
| water to 100 wt % | | | | | | | | | |
| Penetration in mm | 5.9 | 8.2 | 11.5 | 6.1 | 8.5 | 11.9 | 7.5 | 9.4 | >12 |
| Application | slides very | slides | smears | slides very | good | smears | good | smears | smears |
| | well | moderately | | well | | | | | |
| Measured | 4.2 | 25 | 75 | 6.7 | 14 | 115 | 18 | 39 | 254 |
| coefficient of | | | | | | | | | |
| sliding friction | | | | | | | | | |
| Appearance | white | white | white | white | white | white | white | white | white |

“Stearic acid 40%” means in this case that a mixture of different fatty acids with a stearic acid proportion of 40 wt % is present, wherein the remainder is preferably made up of palmitic acid for the most part and myristic acid for the lower part. The same applies to the indication “Stearic acid %” and “stearic acid 98%”, wherein a stearic acid proportion of 50 wt % or 98 wt % is present in each case.

It is evident that the penetration value with a constant proportion of acrylic acid rises as the proportion of stearic acid increases, so that the glue stick becomes softer. The coefficient of sliding friction and the application properties change in the same way. Optimum properties are achieved with a stearic acid proportion of 40 wt %. With regard to the acrylic acid proportion, it is evident that with a proportion of 10-18 wt % within the entire range, very good or good properties result.

In order to make the adhesive properties virtually identical in all glue stick compositions, the quantity of polyacrylate dispersion used was reduced as the acrylic acid proportion rose.

In order to guarantee comparability, the quantity of fatty acids was further reduced as the proportion of acrylic acid rose.

As the proportion of acrylic acid rose, however, the quantity of NaOH used was increased, in order to guarantee complete neutralization of the free acid groups.

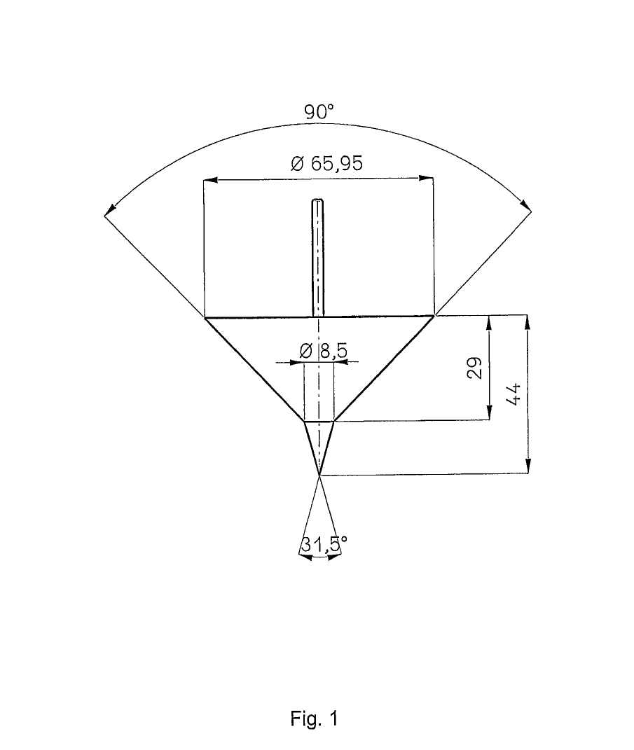

Penetration is the measure of the hardness of the glue sticks. The penetration was measured using a unit produced by Tuninetto, Type 321, Barcelona. For measurement purposes, the glue stick was rotated 10 mm out of the casing and placed in this state under a steel pin (see FIG. 1), such that said pin was in contact with the mass. The pin was then loaded with a 250 g weight for 5 seconds and the penetration depth of the pin measured in mm. The greater the penetration depth, the softer the glue stick.

FIG. 1 shows the steel pin used for the penetration measurement.

In order to determine the coefficient of sliding friction, the following resources were used:

1) Pasting machine plus accessories

2) A4 paper 80 g/m²

3) Stopwatch

4) Glue stick

Work was carried out at a temperature of 19-24° C. and a relative atmospheric humidity of 20-70%.

The following procedure was followed when determining the coefficient of sliding friction:

1) The A4 sheets were cut into strips measuring 297 mm×approx. 42 mm. 5 strips were produced from one A4 page.

2) The paper strip was positioned on the base plate of the pasting machine.

3) The paper was fixed on the base plate by means of a fastening die. Attention had to be paid to ensuring the paper was taut.

4) A movable carriage was mounted on the machine plate.

5) A spacer insert was placed in the carriage slot. This is used for the following adhesive grammages: 8 g, 10 g, 15 g, 20 g.
The spacer insert is not used for 40 g adhesive.

6) The weight for the carriage displacement was chosen according to the adhesive grammage.
8-10 g—weight 300 g;
15-20 g—weight 500 g;
40 g—weight 900 g

7) A cord was used for the carriage displacement. One end of the cord was secured in the carriage opening by means of a hook and the weight was attached to the second end of the cord. The cord was guided via a deflection roller.

8) In the case of the adhesive to be tested, an approx. 10 mm thick strip was cut away.

9) The adhesive was trimmed straight along the plane of the tube connection.

10) After cutting away, the adhesive was rotated out of the tube by 5 mm+/−1 mm.

11) The adhesive was inserted into a casing and the adhesive was fixed in said casing by means of a side screw by tightening it slightly. The weight of the casing was chosen according to the adhesive grammage, such that the adhesive is pressed onto the paper with a vertical pressure of 250 g/cm².

12) The carriage with the weight was extended into the “START” position and the prepared adhesive fixed in the casing was inserted, so that the weight of the casing ensures the necessary pressure of the adhesive on the paper.

13) The carriage with the glue was held in the “START” position with one hand. The stopwatch was held in the second hand.

14) The carriage was released and the stopwatch started at the same time.

15) The time taken for the carriage—driven by the weight guided via the deflection roller—to move from the “START” to the “STOP” position was measured. The length of the glue track applied was approx. 160 mm.

16) The entire process was repeated twice. The adhesive was no longer cut off.

17) In this way, a total of three coefficients of sliding friction were determined. The mean of these values was finally obtained. The coefficient of sliding friction entered in Table 1 corresponds to the time measured in seconds.

1. A glue stick made from an aqueous preparation of an acrylic acid ester copolymer as the adhesive component and a detergent gel as the structure-forming substance, wherein sodium salts of C₁₂ to C₂₂ fatty acids are contained as the gel structure-forming detergent, wherein the acrylic acid ester has an acrylic acid content of 10-25%.

2. The glue stick according to claim 1, wherein the aqueous preparation of an acrylic acid ester copolymer has free acid groups, particularly carboxyl groups.

3. The glue stick according to claim 1, wherein the C₁₂ to C₂₂ fatty acids contain up to 30-50 wt % stearic acid, wherein the remainder is preferably formed from palmitic acid and small quantities of myristic acid.

4. The glue stick according to claim 1, wherein the sodium salts of C₁₂ to C₂₂ fatty acids are contained in quantities of 3-8 wt % relative to the total mass of the stick.

5. The glue stick according to claim 1, wherein the aqueous preparation of an acrylic acid ester copolymer is contained in a quantity of 45-60 wt % relative to the total mass of the stick.

6. The glue stick according to claim 1, wherein the aqueous preparation of an acrylic acid ester copolymer contains sucrose.

7. The glue stick according to claim 1, wherein the aqueous preparation of an acrylic acid ester copolymer contains polyurethane dispersions.

8. The glue stick according to claim 1, wherein the aqueous preparation of an acrylic acid ester copolymer contains starch ether.

9. The glue stick according to claim 1, wherein the glue stick further comprises adjuncts softeners, dyes, pigments, fragrances, preservatives and/or moisture-regulating substances.

10. The glue stick according to claim 9, wherein said glue stick contains, as a softener, monopropylene glycol.

11. A method for producing a glue stick according to claim 1, wherein said method comprises blending C₁₂ to C₂₂ fatty acids as structure-forming parts with an aqueous preparation of an acrylic acid ester copolymer with any acrylic acid content of 10-25%, and, optionally, adjuncts; heating to a temperatures of at least 50° C. until a clear, uniform mixture is created, adding a quantity of sodium hydroxide required to neutralize the fatty acids and the free acid groups if necessary; then homogenizing the mixture; and casting the mixture is cast in moulds and cooling without any mechanical influence to form a gel.

12. The glue stick according to claim 1, wherein the gel structure-forming detergent comprises sodium salts of C₁₄-C₁₈ fatty acids.

13. The glue stick according to claim 1, wherein said acrylic acid ester copolymer has an acrylic acid content of 10-20 wt %.

14. The glue stick according to claim 1, wherein said acrylic acid ester copolymer has an acrylic acid content of 15-20 wt %.

15. The glue stick according to claim 3, wherein said gel structure-forming detergent contains 40-50 wt % stearic acid.

16. The glue stick according to claim 3, wherein said aqueous preparation contains 5-8 wt % of said sodium salts relative to the total mass of said glue stick.

17. The glue stick according to claim 4, wherein in said aqueous preparation said acrylic acid ester copolymer comprises a polyacrylate dispersion.

18. The glue stick according to claim 4, wherein in said aqueous preparation contains 50-60 wt % of said acrylic acid ester copolymer relative to the total mass of said glue stick.
